(19) United States
(12) Patent Application Publication
(10) Pub. No.: US 2014/0104855 A1
(43) Pub. Date: Apr. 17, 2014

(54) APPARATUS AND METHOD FOR FORMING HIGH-RESOLUTION IMAGES FOR LIGHT PATTERN PROJECTION USING ULTRAVIOLET (UV) CURABLE INKS

(71) Applicant: Richard W. Hutton, Dallas, TX (US)

(72) Inventor: Richard W. Hutton, Dallas, TX (US)

(21) Appl. No.: 13/652,602

(22) Filed: Oct. 16, 2012

(51) Int. Cl. B05D 5/06; F21V 9/00; F21V 13/08; B05C 11/00

(52) U.S. Cl. 362/343; 118/641; 427/521; 427/514; 362/351

(57) ABSTRACT

An apparatus includes a gobo configured to be inserted into a projection gate of a projector. The gobo includes a substantially transparent substrate and a coating on the substrate. The coating includes one or more layers of ultraviolet curable ink material. The gobo may also include an adhesion promoter directly on the substrate, where the coating is directly on the adhesion promoter. The coating may include a stack having multiple layers of ultraviolet curable ink material, where the stack includes ink material of at least two different colors. One layer could have white/reflective ultraviolet curable ink material, where that layer is configured to face a light source of the projector. At least one layer of ultraviolet curable ink material could have a varying thickness, which can control a percentage or a color saturation of light transmitted through the at least one layer of ultraviolet curable ink material.

### TECHNICAL FIELD

This disclosure relates generally to light pattern projection. More specifically, this disclosure relates to an apparatus and method for forming high-resolution images for light pattern projection using ultraviolet (UV) curable inks.

### BACKGROUND

Light pattern or image projection is a widely-used way of creating a mood or expression for a particular event or scene in architectural and live performance lighting situations, such as theatrical productions, videos, films, display lighting, and general illumination. Typically, images are created using slide-type devices that are placed in the projection gate of a lighting projector. Each slide is typically called a stencil or “gobo”. Gobos may be as simple as hand-cut or stamped images on stainless steel, brass, or thin aluminum. These types of materials work well with low-level light sources and low-resolution projections and lenses.

More recent pattern generation has been accomplished with laser cut and acid etched metal gobos. However, there are many well-known drawbacks to using metal gobos. Many attempts have also been made to produce gobos with near-photographic quality images. The processes for forming these types of gobos are typically very complex. They can involve vacuum-depositing dichroic materials on glass substrates and then etching the substrates with chemicals or lasers to form high-resolution multi-colored gobos, usually at great expense.

Until recently, incandescent or arc-type lamps were traditionally used in projection systems. However, these types of lamps generate enormous amounts of heat that can be transmitted through projection gates and easily destroy many types of gobos. As a result, the projection industry recently started using light sources that contain light emitting diodes (LEDs). These light sources can have outputs comparable to many traditional types of lamps with greatly reduced heat load. While there is still heat generated from visible energy passing through a projection gate, infrared and ultraviolet portions of light produced by older lamp technologies may not be present in the LEDs' outputs. There are already higher-powered LED-based projectors on the market that have tremendous amounts of output power, but they still typically require the use of more complex methods of gobo manufacturing. There is also an emerging range of lower-powered LED-based projectors.

### SUMMARY

This disclosure provides an apparatus and method for forming high-resolution images for light pattern projection using ultraviolet (UV) curable inks.

In a first embodiment, an apparatus includes a gobo configured to be inserted into a projection gate of a projector. The gobo includes a substantially transparent substrate and a coating on the substrate. The coating includes one or more layers of ultraviolet curable ink material.

In a second embodiment, a system includes a deposition unit configured to deposit one or more layers of ultraviolet curable ink on a substantially transparent substrate. The system also includes a curing unit configured to cure the one or more layers of ultraviolet curable ink to form a coating having one or more layers of ultraviolet curable ink material on the substrate. The substantially transparent substrate and the coating form at least a portion of a gobo configured to be inserted into a projection gate of a projector.

In a third embodiment, a method includes obtaining a substantially transparent substrate and forming a coating on the substrate. The coating includes one or more layers of ultraviolet curable ink material. The substantially transparent substrate and the coating form at least a portion of a gobo configured to be inserted into a projection gate of a projector.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIGS. 1 through 4 illustrate an example gobo having ultraviolet (UV) curable inks in accordance with this disclosure;

FIGS. 5 through 8 illustrate example fabricated gobos having UV curable inks in accordance with this disclosure;

FIG. 9 illustrates an example system for manufacturing gobos having UV curable inks in accordance with this disclosure;

FIG. 10 illustrates an example method for manufacturing gobos having UV curable inks in accordance with this disclosure;

FIG. 11 illustrates an example gobo having UV curable inks arranged to support grayscale control in accordance with this disclosure; and

FIG. 12 illustrates an example gobo having UV curable inks arranged to support color saturation control in accordance with this disclosure.

### DETAILED DESCRIPTION

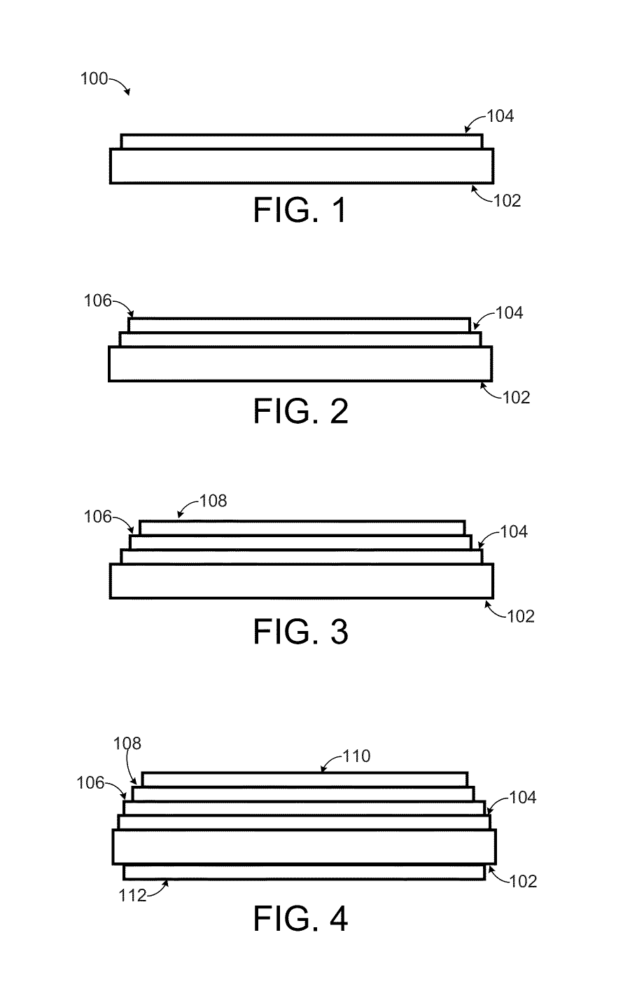

FIGS. 1 through 12, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

In general, this disclosure describes a method for producing high-resolution gobos using ultraviolet (UV) curable inks. The gobos could be formed using a monolithic, flexible or rigid substrate or other suitable substrate. This disclosure also provides a system for manufacturing high-resolution gobos, such as via printing of UV curable inks.

Monolithic Printed Substrates

A gobo includes a substantially transparent substrate coated with an adhesion promoter. At least one UV curable ink is deposited on the adhesion promoter, and one or more UV curable inks can be deposited on top of the ink(s) on the adhesion promoter. The inks are cured with UV light at any suitable wavelength(s). One or multiple colors of ink could be used when manufacturing the gobo. The use of UV curable inks allows thicker, but controllable, amounts of ink to be deposited onto a substrate. Among other things, this can provide improved optical density and saturation for full-spectrum color. This can facilitate the production of gobos that are comparable to more expensive dichroic gobos. Alternatively, custom-designed inks can be tailored to produce alternate optical properties on a gobo, such as an anti-reflective coating or reflective metallic inks. A substrate coated in this way may be used to fabricate a monolithic full-color high-resolution gobo on a flexible or rigid substrate. Such a substrate may also be used for making a black-and-white or grayscale gobo.

FIGS. 1 through 4 illustrate an example gobo 100 having UV curable inks in accordance with this disclosure. The gobo 100 can be manufactured to have any suitable black and white, grayscale, or color image(s).

As shown in FIG. 1, the gobo 100 includes a substantially transparent substrate 102. The substrate 102 is generally transparent to light in a wavelength range of interest, such as from about 400 nm to about 700 nm. The substrate 102 can be formed from any suitable material(s), such as glass or plastic. In particular embodiments, the substrate 102 could represent a thin flexible plastic film, rigid plastic substrate, or glass material having a low coefficient of thermal expansion. Other transparent rigid or flexible material(s) may be used depending on the application, such as for low heat applications like certain LED projectors or other applications.

On one side of the substrate 102 is an adhesion promoter 104. The adhesion promoter 104 serves as an etchant to generate pores in the substrate 102 and to act as a binder to one or more UV curable inks. This creates good adhesion at both the substrate-adhesion promoter interface and the adhesion promoter-ink interface. The adhesion promoter 104 can also be visually transparent in clear areas of a gobo being fabricated. The adhesion promoter 104 includes any suitable material(s) that can bond to a substrate and one or more UV curable inks. The adhesion promoter 104 could also be deposited or otherwise formed in any suitable manner, such as by direct printing onto the substrate 102. In some embodiments, the adhesion promoter 104 could be deposited only on the areas of the substrate 102 where ink will be deposited so that clear areas remain untouched. In other embodiments, the substrate 102 could be pre-etched with an acid-based solution or in any other suitable manner to form micro-pores in the substrate 102, thereby forming an “adhesion surface” that provides a bonding surface for UV curable ink.

As shown in FIG. 2, a first layer of UV curable ink 106 is deposited on the adhesion promoter 104. As shown in FIG. 3, a second layer of UV curable ink 108 can be deposited on the first layer of UV curable ink 106. Each layer of UV curable ink 106-108 could include ink(s) of any suitable color(s), such as yellow, magenta, cyan, black, clear, white, reflective metallic, or any combination thereof. Each layer of UV curable ink 106-108 could also be formed in any suitable manner, such as by direct printing a UV curable ink. Each layer of UV curable ink 106-108 or portion thereof could be cured using ultraviolet light to help harden the ink. The cured ink can be solvent- and abrasion-resistant and can have a higher temperature resistance than other printing methods.

Any number of layers of UV curable ink could be used to form a stack in the gobo 100. Also, any number of colors of ink in any suitable pattern could be used in the gobo 100. Because a manufacturer has control over which inks are deposited and in what order, any suitable depositions can occur. For instance, it is possible to first deposit white ink or reflective metallic ink in areas of the gobo 100 that will be black and then deposit black ink on top of the first ink. This allows the white or reflective areas to face a light source and reduce the heat load on the black ink, while the black ink can face the lens system of a projector. The black ink can therefore act as a block to stop the passing of light in certain areas of the gobo and as a dark mirror to absorb back reflections from the lens system of the projector. In other embodiments, the black and white/reflective inks could be reversed, and the gobo 100 can be installed so that the white or reflective ink faces the light source and the black ink faces the lens system. In still other embodiments, the black ink could be replaced with any number of combinations of ink that could be combined to produce a black color. Note that any other or additional color(s) could be used in the gobo 100. Also note that it is possible to deposit a clear coating of ink over the finished product to add even greater durability to the gobo 100.

As shown in FIG. 4, an anti-reflective type coating 110 can be formed on one side of the substrate 102, and an anti-reflective type coating 112 can be formed on another side of the substrate 102. The anti-reflective type coatings 110-112 can be used to improve optical transmission in a projection. Each anti-reflective type coating 110-112 could be formed using any suitable anti-reflective material(s). Each anti-reflective type coating 110-112 could also be formed in any suitable manner. While shown here as including an anti-reflective type coating on each side of the substrate 102, an anti-reflective type coating could be used on only one side or on neither side of the substrate 102. In other embodiments, the substrate 102 could have a pre-coated anti-reflective layer deposited on one or both sides of the substrate 102 by any suitable mechanism, such as vacuum deposition.

Although FIGS. 1 through 4 illustrate one example of a gobo 100 having UV curable inks, various changes may be made to FIGS. 1 through 4. For example, the gobo 100 could include any number of UV curable ink layers of any suitable color(s) and in any suitable pattern(s). Also, one or more UV curable ink layers could be used on each side of the substrate 102.

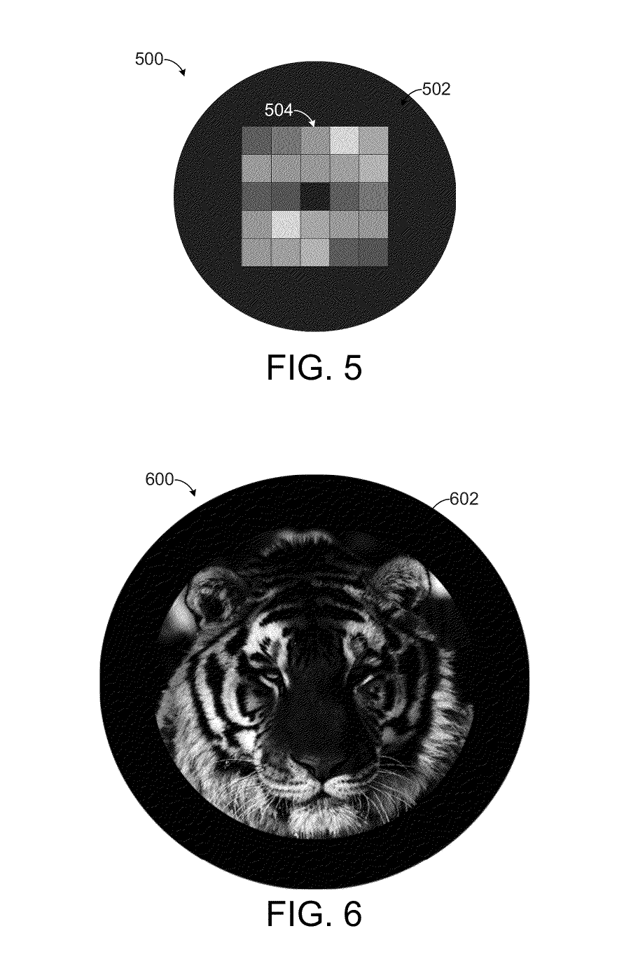

FIGS. 5 through 8 illustrate example fabricated gobos having UV curable inks in accordance with this disclosure. In FIG. 5, a gobo 500 is a full-color gobo that includes an outer area 502 with black ink and areas 504 with different colors. In FIG. 6, a gobo 600 is a black-and-white gobo that includes an outer area 602 with black ink and an area 604 with a black-and-white photographic image.

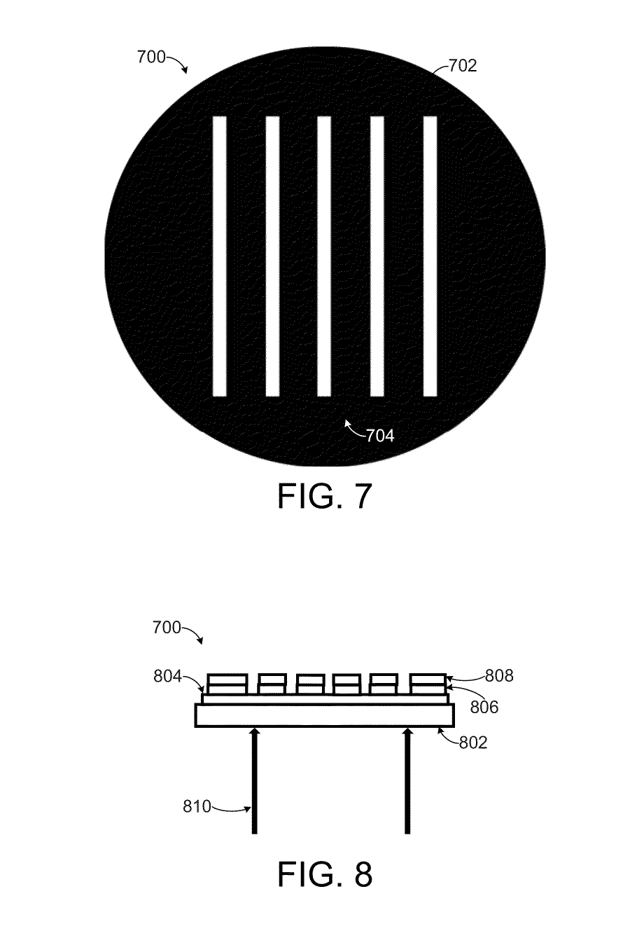

In FIGS. 7 and 8, a gobo 700 is a black-and-white gobo that includes an outer area 702 with black ink and an area 704 with rectangular white sections. The gobo 700 includes a substrate 802, an adhesion promoter 804, and two patterned layers of UV curable ink 806-808. The layer of UV curable ink 806 could represent white ink or a reflective metallic ink, and the layer of UV curable ink 808 could represent black ink. Light 810 could enter the gobo 800 through the substrate 802, and the patterning of the layers 806-808 could create the rectangular white sections in the area 704 as shown in FIG. 7.

These gobos 500-800 are meant to represent various types of gobos that could be manufactured using UV curable ink(s). Any other suitable gobos could be manufactured using UV curable ink(s) on a flexible glass, flexible plastic, or other flexible or non-flexible substrate. These gobos could have any suitable black-and-white, grayscale, or color image(s).

Manufacturing Systems and Techniques

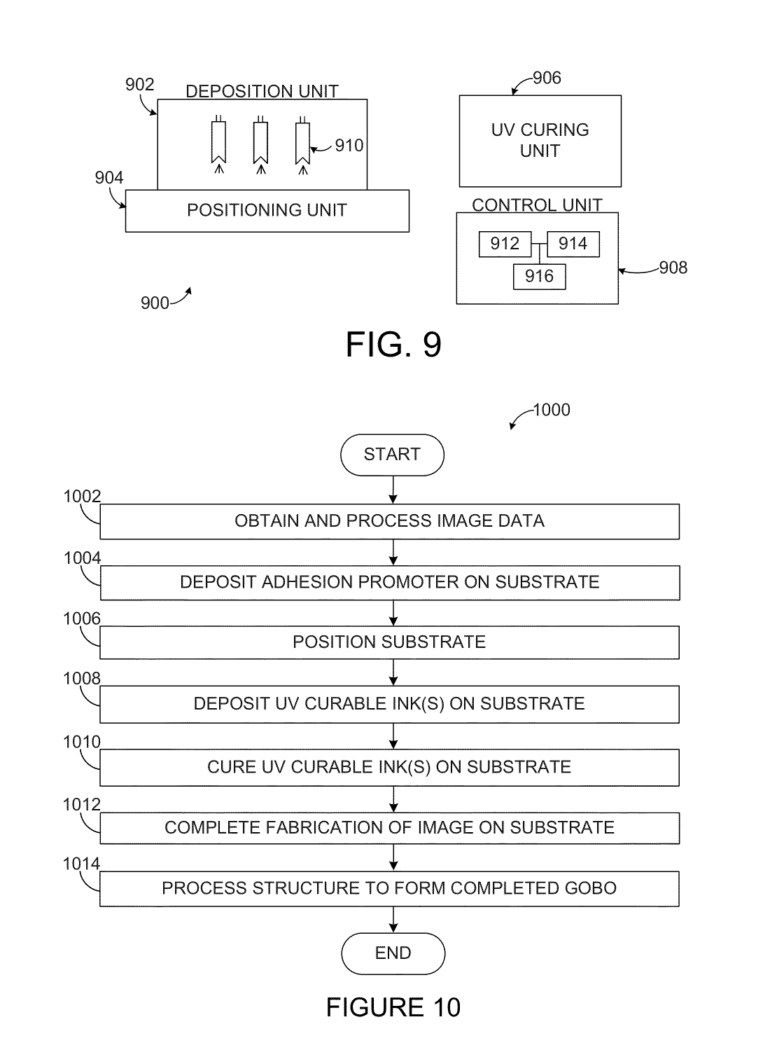

FIG. 9 illustrates an example system 900 for manufacturing gobos having UV curable inks in accordance with this disclosure. As shown in FIG. 9, the system 900 includes a deposition unit 902, a positioning unit 904, a curing unit 906, and a control unit 908. Note that the functional division shown here is for illustration only, and various units 902-908 could be integrated into a single functional unit. For example, the deposition unit 902 and the positioning unit 904 could be combined into a single printer system or other type of deposition device. As another example, the curing unit 906 could be integrated into the deposition unit 902 so that UV curable ink can be cured within the deposition unit 902 as soon as the ink is deposited on a substrate.

The deposition unit 902 includes any suitable structure for depositing one or more UV curable inks, and possibly other materials such as an adhesion promoter, onto a substrate. For example, the deposition unit 902 could include a printer system having one or more print heads 910 for depositing UV curable pigmented inks or other materials onto a substrate. In particular embodiments, the deposition unit 902 represents a direct jet printer. Note that the deposition unit 902 may or may not deposit the adhesion promoter onto a substrate. If it does not, the adhesion promoter could be applied to a substrate in other ways, such as by wiping, brushing, spraying, or spinning the adhesion promoter onto the substrate. In other embodiments, the substrate could be pre-etched with an acid-based solution or in any other suitable manner to form micro-pores in the substrate.

The positioning unit 904 can optionally be used to move or otherwise position a substrate within or adjacent to the deposition unit 902. Any suitable type of positioning unit 904 could be used in the system 900. For example, the positioning unit 904 could represent a translation table or other structure that physically moves a substrate in multiple dimensions. The positioning unit 904 could also include a feeding system that feeds a substrate through the deposition unit 902 along a single dimension. Note that the use of the positioning unit 904 is optional since an operator could place a substrate within the deposition unit 902, and the print heads 910 or other structure(s) within the deposition unit 902 could move over the substrate and deposit the UV curable ink(s).

The curing unit 906 is used to cure the UV curable ink(s) deposited on the substrate. The curing unit 906 includes any suitable structure for curing UV curable ink. The curing unit 906 could, for example, include one or more ultraviolet LEDs or other structures that generate UV light at one or more wavelengths. Note that in this document, the phrases “UV curable ink material” and “ultraviolet curable ink material” refer to material remaining after a UV curable ink has been cured. The control unit 908 controls the overall operation of the system 900. For example, the control unit 908 could receive image data and control the operation of the deposition unit 902 to control the formation of an image on a substrate. The control unit 908 could also control the positioning unit 904 to control the position of the substrate and control the curing unit 906 to control the curing of ink on the substrate.

The control unit 908 includes any suitable structure for controlling operation of one or more components. In this example, the control unit 908 includes one or more processing devices 912 (such as at least one microprocessor, microcontroller, DSP, FPGA, or ASIC). The control unit 908 also includes one or more memories 914 storing instructions and data used, generated, or collected by the processing device(s). The control unit 908 further includes one or more interfaces 916 supporting communication over at least one wired or wireless link (such as an Ethernet interface or a wireless transceiver). In particular embodiments, the control unit 908 uses Raster Image Processor (RIP) software to control the deposition of UV curable inks onto a substrate to form an image.

In one particular implementation, the system 900 could have the following features. The deposition unit 902 and the positioning system 904 are implemented using a small-format high-resolution flatbed printer system capable of positioning multiple types of substrates under print heads 910 using position feedback translating slides. The Z-axis of the translating slides can use electronic feedback and a lead screw drive to accurately control the distance of the substrate from the print heads 910. The printing resolution can be 1440×5760 dots per inch or other suitable resolution. The RIP software in the control unit 908 receives an image in digital format and, through a user interface, all aspects of control can be tailored to achieve the desired output from the print heads 910. This can include user input controlling the ink deposition amount (such as between 1.5 pico-liters and 21 pico-liters per droplet size and curing time or intensity control of the curing unit's UV LEDs). The system 900 could be scaled to allow numerous articles to be printed for mass production. A suitable printer system with RIP software could be obtained, for example, from DIRECT COLOR SYSTEMS of Rocky Hill, Conn. Note that this represents one specific implementation of the system 900 and that other implementations could also be used.

Although FIG. 9 illustrates one example of a system 900 for manufacturing gobos having UV curable inks, various changes may be made to FIG. 9. For example, various other systems could be used to produce the described gobos. Also, the system 900 could be used to deposit any number of colored inks onto a substrate, including a single color of ink. In addition, the system 900 shown here could be used in many other applications, such as to produce printed plaques and awards or customized portable electronics art, manufacture photographs on glass for scientific, medical, and entertainment applications, or create custom linear and circular color filters for scientific and medical LED-based test instruments used in all areas of life. Specific applications can include solar applications, visual displays, and anti-counterfeit applications. The system 900 could also be integrated into a robotic or other online production environment for high-volume hands-free manufacturing.

FIG. 10 illustrates an example method 1000 for manufacturing gobos having UV curable inks in accordance with this disclosure. As shown in FIG. 10, image data is obtained and processed at step 1002. This could include, for example, the control unit 908 receiving image data and processing the image data using RIP or other software. The processing identifies the color(s) of UV curable ink(s) to be deposited on a substrate and the locations for the deposition of the ink(s) in order to create a desired image.

An adhesion promoter is deposited on the substrate at step 1004. This could include, for example, the control unit 908 causing the deposition unit 902 to deposit the adhesion promoter on the substrate. As noted above, however, other techniques could be used to deposit the adhesion promoter on the substrate, such as by wiping, brushing, spraying, or spinning the adhesion promoter onto the substrate. In these embodiments, the control unit 908 may or may not have the ability to control the deposition of the adhesion promoter on the substrate.

The substrate is positioned at step 1006, one or more UV curable inks are deposited on the substrate at step 1008, and the one or more UV curable inks are cured at step 1010. This could include, for example, the control unit 908 causing the print heads 910 of the deposition unit 902 to deposit UV curable ink(s) of one or more colors onto specified areas of the substrate. At least one ink is deposited on the adhesion promoter, while one or more additional inks could be deposited on top of the ink(s) on the adhesion promoter. Each deposition of ink could be immediately followed by UV curing, which can be done to obtain reduced or minimized pixel size and increased or maximized pixel density.

Fabrication of the image on the substrate is completed at step 1012. This could include, for example, performing any other processing steps to finalize the image on the substrate, such as deposition of one or more clear inks on an image to help protect the image. The structure is processed to form a completed gobo at step 1014. This could include, for example, forming one or more anti-reflective layers or other layers of material on one or both sides of the substrate.

Although FIG. 10 illustrates one example of a method 1000 for manufacturing gobos having UV curable inks, various changes may be made to FIG. 10. For example, while shown as a series of steps, various steps in FIG. 10 could overlap, occur in parallel, occur in a different order, or occur any number of times. As a particular example, steps 1006-1010 could occur repeatedly, where the substrate is placed in one location and ink is deposited and cured before these steps are repeated at another location. Also, one or more UV curable ink layers could be used on each side of the substrate.

Image Generation

Images created on gobos, such as using the system 900 of FIG. 9, could be generated in any suitable manner. In some embodiments, digital data representing a desired image is provided to and processed using RIP software. The software can determine color values for each pixel or area of the desired image. When the printing process is initiated, the software can control the print heads 910 to, for example, release highly-controlled droplets of ink in precise areas. As the ink is released, one or more corresponding UV LEDs or other structures can be energized to instantly cure the droplets in place to provide reduced/minimum pixel size and increased/maximum pixel density.

Grayscale and Color Saturation Control

The ability to control the thickness of each droplet of ink as it is deposited on a substrate allows a system, such as the system 900 of FIG. 9, to control the amount of light that passes through that particular pixel. This works in grayscale control and in the control of the amount of white light that passes through a color pixel (in that a thicker droplet provides more saturated color until reaching full saturation).

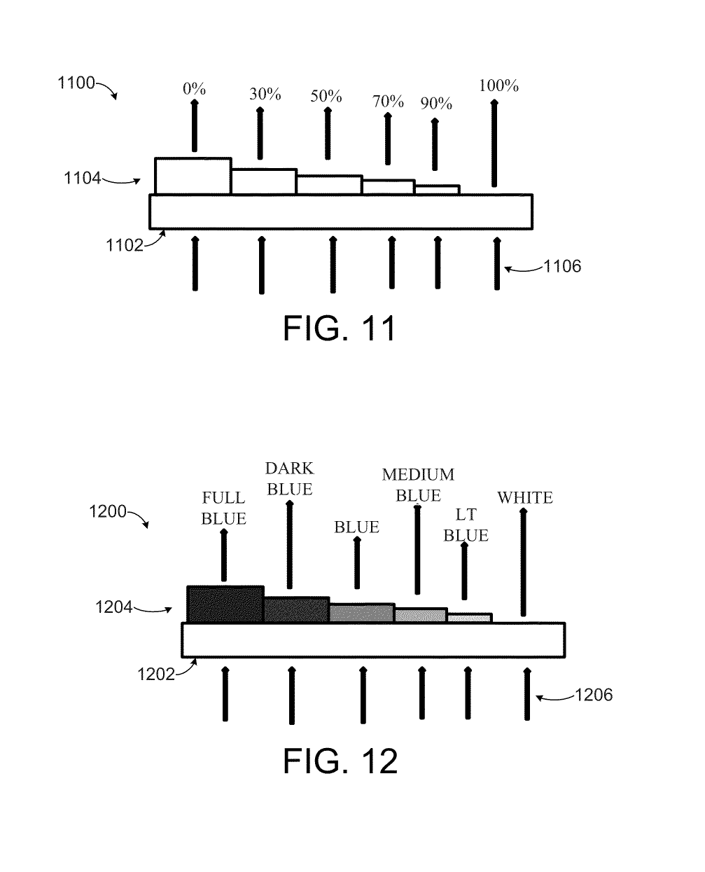

FIG. 11 illustrates an example gobo 1100 having UV curable inks arranged to support grayscale control in accordance with this disclosure. As shown in FIG. 11, the gobo 1100 includes a substrate 1102 and a layer of ink 1104 (black ink in this example). Light 1106 (typically white light) enters the substrate 1102, and the layer of ink 1104 has different heights in different locations and is even absent in some locations. As a result, different amounts of the light 1106 are transmitted through the gobo 1100 at different locations, showing that it is possible to achieve grayscale control by varying the amount of ink deposited on the substrate 1100.

FIG. 12 illustrates an example gobo having UV curable inks arranged to support color saturation control in accordance with this disclosure. As shown in FIG. 12, the gobo 1200 includes a substrate 1202 and a layer of ink 1204 (blue ink in this example). Light 1206 (typically white light) enters the substrate 1202, and the layer of ink 1204 has different heights in different locations and is even absent in some locations. As a result, colors with different saturations are created using the layer of ink 1204, showing that it is possible to achieve color saturation control by varying the amount of ink deposited on the substrate 1200.

Although FIGS. 11 and 12 illustrate examples of gobos 1100 and 1200 having UV curable inks arranged to support grayscale control and color saturation control, various changes may be made to FIGS. 11 and 12. For example, any other ink thicknesses could be used to create other grayscale or color saturation values.

Potential Advantages

The systems and methods described above could have various advantages depending on the implementation. For example, the systems and methods described above do not require the use of a vacuum deposition and chemical etching system or a laser system, which helps to eliminate the expenses associated with those types of systems. Also, the systems and methods described above can more rapidly create gobos in large quantities than vacuum deposition and laser systems, which can require significant amounts of time to manufacture gobos. Further, the systems and methods described above do not suffer from problems typically associated with laser systems, such as heat affect zones (where melting of metal creates larger features than desired) and micro-pits in a substrate (which causes haze in an image). Moreover, the systems and methods described above can require fewer manufacturing steps, reducing the likelihood that an error in one step renders a gobo unusable. In addition, the systems and methods described above can achieve improved optical density values in manufactured gobos, such as in the range of 3.0 and greater (a more specific range is 4.5 or greater). This allows gobos to achieve color saturations previously unobtainable using other printing technologies and allows gobos to be produced that compare with those manufactured using more expensive technologies. The systems and methods described above, as well as alterations thereof, could have any other or additional advantages depending on the implementation.

Note that in the above description, material is routinely described as being deposited or otherwise formed “on” another layer of material or other structure. This does not require direct contact, as one or more intermediate structures could be present between structures. The phrase “directly on” is used in this document to denote physical contact between two structures. Also note that values given above (such as optical density values) are approximate values only.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
a gobo configured to be inserted into a projection gate of a projector, the gobo comprising:
a substantially transparent substrate; and
a coating on the substrate, the coating comprising one or more layers of ultraviolet curable ink material.

2. The apparatus of claim 1, wherein the gobo further comprises:
an adhesion promoter directly on the substrate, the coating directly on the adhesion promoter.

3. The apparatus of claim 1, wherein the coating comprises a stack having multiple layers of ultraviolet curable ink material, the stack comprising ink material of at least two different colors.

4. The apparatus of claim 1, wherein the coating forms an image having an optical density of about 3.0 or greater.

5. The apparatus of claim 1, wherein the coating comprises a stack having multiple layers of ultraviolet curable ink material, one of the layers comprising a white layer having white ultraviolet curable ink material, the white layer configured to face a light source when the apparatus is inserted into the projection gate of the projector.

6. The apparatus of claim 1, wherein the coating comprises a stack having multiple layers of ultraviolet curable ink material, one of the layers comprising a reflective layer having reflective ultraviolet curable ink material, the reflective layer configured to face a light source when the apparatus is inserted into the projection gate of the projector.

7. The apparatus of claim 1, wherein the gobo further comprises at least one of:
a first anti-reflective coating on a first side of the substrate; and
a second anti-reflective coating on a second side of the substrate.

8. The apparatus of claim 1, wherein at least one layer of ultraviolet curable ink material has a varying thickness.

9. The apparatus of claim 8, wherein the varying thickness of the at least one layer of ultraviolet curable ink material controls a percentage of light transmitted through the at least one layer of ultraviolet curable ink material.

10. The apparatus of claim 8, wherein the varying thickness of the at least one layer of ultraviolet curable ink material controls a color saturation of light transmitted through the at least one layer of ultraviolet curable ink material.

11. The apparatus of claim 1, wherein the one or more layers of ultraviolet curable ink material form at least one of: a black and white image, a grayscale image, and a color image.

12. A system comprising:
a deposition unit configured to deposit one or more layers of ultraviolet curable ink on a substantially transparent substrate; and
a curing unit configured to cure the one or more layers of ultraviolet curable ink to form a coating comprising one or more layers of ultraviolet curable ink material on the substrate;
wherein the substantially transparent substrate and the coating form at least a portion of a gobo configured to be inserted into a projection gate of a projector.

13. The system of claim 12, wherein the deposition unit is configured to deposit at least one layer of ultraviolet curable ink directly on an adhesion promoter that is directly on the substrate.

14. The system of claim 13, wherein the deposition unit is further configured to deposit the adhesion promoter directly on the substrate.

15. The system of claim 12, wherein the deposition unit is configured to deposit ultraviolet curable ink of at least two different colors on the substrate.

16. The system of claim 12, wherein the one or more layers of ultraviolet curable ink material form an image having an optical density of about 3.0 or greater.

17. The system of claim 12, further comprising:
a positioning unit configured to change a position of the substrate relative to one or more print heads within the deposition unit.

18. The system of claim 12, wherein the curing unit comprises one or more ultraviolet light emitting diodes within the deposition unit.

19. The system of claim 12, further comprising:
a control unit configured to receive image data and to control the deposition unit in order to control formation of an image on the substrate.

20. A method comprising:
obtaining a substantially transparent substrate; and
forming a coating on the substrate, the coating comprising one or more layers of ultraviolet curable ink material;
wherein the substantially transparent substrate and the coating form at least a portion of a gobo configured to be inserted into a projection gate of a projector.

21. The method of claim 20, further comprising:
forming an adhesion promoter directly on the substrate, the coating formed directly on the adhesion promoter.

22. The method of claim 20, further comprising:
forming an adhesion surface directly on the substrate, the coating formed directly on the adhesion surface.

23. The method of claim 20, wherein the coating comprises a stack having multiple layers of ultraviolet curable ink material, the stack comprising ink material of at least two different colors.

24. The method of claim 20, wherein the coating forms an image having an optical density of about 3.0 or greater.

25. The method of claim 20, further comprising at least one of:
forming a first anti-reflective coating on a first side of the substrate; and
forming a second anti-reflective coating on a second side of the substrate.

26. The method of claim 20, wherein at least one layer of ultraviolet curable ink material has a varying thickness to control at least one of:
a percentage of light transmitted through the at least one layer of ultraviolet curable ink material; and
a color saturation of light transmitted through the at least one layer of ultraviolet curable ink material.
